(19) United States
(12) Patent Application Publication
(10) Pub. No.: US 2015/0122764 A1
(43) Pub. Date: May 7, 2015

(54) Baby Bottle

(71) Applicant: Nicole Freeman, Lithonia, GA (US)

(72) Inventor: Nicole Freeman, Lithonia, GA (US)

(21) Appl. No.: 14/526,874

(22) Filed: Oct. 29, 2014

Related U.S. Application Data
(60) Provisional application No. 61/900,427, filed on Nov. 6, 2013.

(51) Int. Cl. A61J 9/00

(52) U.S. Cl. CPC A61J 9/008
USPC 215/11.1

(57) ABSTRACT

An improved baby bottle whose top is angled to reduce the ingestion of air, which causes gas pain for the infant. The bottle features a glow-in-the-dark bottle measurement strip along the side, to indicate the volume of milk or formula remaining in the bottle. The base and cap of the bottle are removable, and may be assembled as a separate container to carry medicine, fruit juice, a pacifier, or other small items, or used as a pacifier. The base and cap may also be used to measure medicine or dry formula, and the base measurement strip also glows in the dark. Dry formula or other materials may also be stored in the base while it is attached to the bottle.

### CROSS-REFERENCE TO RELATED APPLICATIONS

This application claims the benefit of U.S. Provisional Application No. 61/900427, filed Nov. 6, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant care accessories and in particular to an improved baby bottle. Raising a baby is a challenge, particularly for parents who are working, going to school, or caring for older children. The amount of clothing, toys, equipment and accessories can be daunting, and the diaper bag keeps getting heavier. Finding an infant care item which can be used to perform multiple tasks would be gratifying for young, working parents. An improved baby bottle, with a combination of features and attachments which can be used for multiple tasks, would address this demand. The top of the bottle is angled relative to the to reduce the ingestion of air, which causes gas pain for the infant. The bottle features a glow-in-the-dark bottle measurement strip along the side, to indicate the volume of milk or formula remaining in the bottle. The base and cap of the bottle are removable, and may be assembled as a separate container to carry medicine, fruit juice, a pacifier, or other bulk product to be served or transported in a small quantity, or used as a pacifier. The base and cap may also be used to measure medicine or dry formula, and the bottle measurement strip also glows in the dark. Dry formula or other materials may also be stored in the base while it is attached to the bottle.

### SUMMARY OF THE INVENTION

Accordingly, the invention is directed to an improved baby bottle. The top of the bottle is angled to reduce the ingestion of air, which causes gas pain for the infant. The bottle features a glow-in-the-dark bottle measurement strip along the side, to indicate the volume of milk or formula remaining in the bottle. The base and cap of the bottle are removable, and may be assembled as a separate container to carry medicine, fruit juice, a pacifier, or other small items, or used as a pacifier. The base and cap may also be used to measure medicine or dry formula, and the bottle measurement strip also glows in the dark. Dry formula or other materials may also be stored in the base while it is attached to the bottle.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a side view perspective of the first exemplary embodiment with the base detached, displaying the bottle 10, the cap 11, the nipple 11A, the bottle measurement strip 12, the base 13, and the base measurement strip 14.

FIG. 2 shows a side perspective view of the tall base and base components of the first exemplary embodiment, displaying the base 13, the base measurement strip 14, and the tall base 15.

FIG. 3 shows a side perspective view of the cap and base components of the first exemplary embodiment assembled as a container, displaying the cap 11, the nipple 11A, the base 13, and the base measurement strip 14.

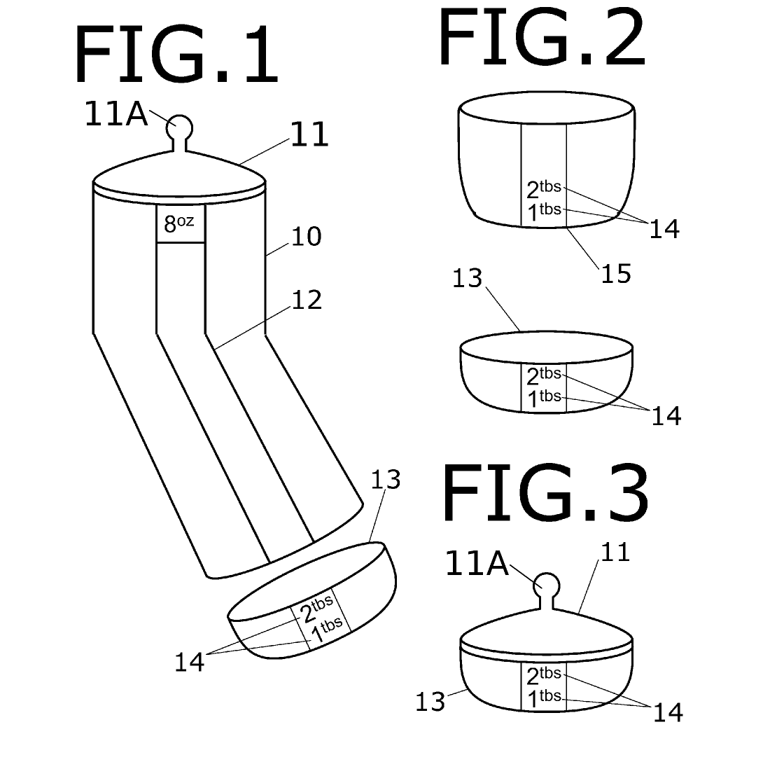

### DETAILED DESCRIPTION OF THE INVENTION

Referring now to the invention in more detail, the invention is directed to an improved baby bottle 10. The top of the bottle 10 is angled to reduce the ingestion of air, which causes gas pain for the infant. The bottle is open on its top end, where the cap 11 is releasably attached, and is closed on its bottom end, where the base 13 or tall base 15 is releasably attached. The bottle 10 features a glow-in-the-dark bottle measurement strip 12 along the side, to indicate the volume of milk or formula remaining in the bottle. The base 13 and cap 11 of the bottle 10 are removable, and may be assembled as a separate container to carry medicine, fruit juice, a pacifier, or other small items, or used as a pacifier. The base 13 and cap 11 may also be used to measure medicine or dry formula, and the base measurement strip 14 also glow in the dark. Dry formula or other materials may also be stored in the base 13 while it is attached to the bottle 10. The bottle 10, cap 11, and at least one of the base 13 or the tall base 15 together form a system.

The first exemplary embodiment consists of four components: the bottle 10, the cap 11, the base 13, and the tall base 15. The base 13 and tall base 15 feature threads for attachment to the bottom of the bottle 10. The cap 11 is also threaded for attachment to the top of the bottle. The threads may be used to attach the cap 11 to either the base 13, or the tall base 15, to create a separate container. All of the components may be disassembled, and the nipple 11A may also be removed from the cap 11, for cleaning purposes. The cap 11 features a removable transparent cover to keep the nipple 11A clean and dry. All components are heat resistant, shatterproof, and dishwasher safe.

To use the first exemplary embodiment, the user may pour an appropriate amount of water into the bottle 10, and attach the cap 11 to the top of the bottle 10. The user may then pour an appropriate amount of dry formula into either the base 13 or the tall base 15, and attach it to the bottom of the bottle 10. The amounts of water and dry formula may be measured in limited-light settings through use of the bottle measurement strip 12 and the base measurement strip 14. The bottle 10 may then be carried in a diaper bag or other container until needed. At feeding time, the user may remove the base 13 or tall base 15 from the bottom of the bottle 10, remove the cap 11 from the top of the bottle 10, and pour the dry formula into the bottle 10. The user may then shake the bottle 10 until the formula is thoroughly mixed, remove the transparent cover from the cap 11, and feed the infant. The cap 11 and the base 13 or tall base 15 may then be rinsed out and assembled as a small container to serve juice or medicine, or to be used as a pacifier.

The bottle 10, cap 11, base 13, and tall base 15 are preferably manufactured from a semi-rigid, durable, translucent material that is shatterproof, dishwasher safe, and heat resistant, such as high-impact plastic or acrylic polymer. The nipple 11A is preferably manufactured from a flexible, durable material that is dishwasher safe and heat resistant, such as silicone. The cover is preferably manufactured from a rigid, durable, transparent material that is dishwasher safe and heat resistant, such as plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A baby bottle system comprising a bottle; said bottle being angled; said bottle being open on its top and closed in its bottom; a cap; said cap and the top of said bottle being releasably affixable to each other; a nipple; said nipple being removably disposed within said cap; at least one of a base or a tall base; said at least one of a base or a tall base being open on its top and closed in its bottom; said cap and said at least one of said base or tall base being releasably affable to each other; the bottom of said bottle being releasably engageable to the top said at least one of said base or tall base.

2. The baby bottle system of claim 1 wherein said at least one of a base or a tall base comprises both a base and a tall base.

3. The baby bottle system of claim 1 further comprising a bottle measurement strip; said bottle measurement strip being affixed to the side of said bottle; said bottle measurement-strip being of a glow-in-the-dark material.

4. The baby bottle system of claim 1 further comprising a base measurement strip; said base measurement strip being affixed to the side of each of said at least one of a base or a tall base; said base measurement strip being of a glow-in-the-dark material.

5. The baby bottle system of claim 2 further comprising a base measurement strip; said base measurement strip being affixed to the side of each of said at least one of a base or a tall base; said base measurement strip being of a glow-in-the-dark material.

6. The baby bottle system of claim 3 further comprising a base measurement strip; said base measurement strip being affixed to the side of each of said at least one of a base or a tall base; said base measurement strip being of a glow-in-the-dark material.

7. The baby bottle system of claim 2 further comprising a bottle measurement strip; said bottle measurement strip being affixed to the side of said bottle; said bottle measurement-strip being of a glow-in-the-dark material.

8. The baby bottle system of claim 5 further comprising a bottle measurement strip; said bottle measurement strip being affixed to the side of said bottle; said bottle measurement-strip being of a glow-in-the-dark material.

9. A method of using the baby bottle system of claim 1 comprising placing a small quantity of bulk product in said at least one of a base or a tall base, affixing said cap to said at least one of a base or a tall base, and serving said small quantity of bulk product.

10. A method of using the baby bottle system of claim 1 comprising affixing said cap to said at least one of a base or a small base, and using the resulting combination as a pacifier.

11. A method of using the baby bottle system of claim 7 comprising affixing said cap to said at least one of a base or a small base, and using the resulting combination as a pacifier.

12. A method of using the baby bottle system of claim 7 comprising placing a small quantity of bulk product in said at least one of a base or a tall base, affixing said cap to said at least one of a base or a tall base, and serving said small quantity of bulk product.

13. A method of using the baby bottle system of claim 12 comprising affixing said cap to said at least one of a base or a small base, and using the resulting combination as a pacifier.

14. A method of using the baby bottle system of claim 5 comprising placing a small quantity of bulk product in said at least one of a base or a tall base, affixing said cap to said at least one of a base or a tall base, and serving said small quantity of bulk product.

15. A method of using the baby bottle system of claim 5 comprising affixing said cap to said at least one of a base or a small base, and using the resulting combination as a pacifier.

16. A method of using the baby bottle system of claim 15 comprising placing a small quantity of bulk product in said at least one of a base or a tall base, affixing said cap to said at least one of a base or a tall base, and serving said small quantity of bulk product.

17. A method of using the baby bottle system of claim 8 comprising affixing said cap to said at least one of a base or a small base, and using the resulting combination as a pacifier.

18. A method of using the baby bottle system of claim 8 comprising placing a small quantity of bulk product in said at least one of a base or a tall base, affixing said cap to said at least one of a base or a tall base, and serving said small quantity of bulk product.

19. A method of using the baby bottle system of claim 18 comprising affixing said cap to said at least one of a base or a small base, and using the resulting combination as a pacifier.

20. A method of using the baby bottle system of claim 2 comprising placing a small quantity of bulk product in said at least one of a base or a tall base, affixing said cap to said at least one of a base or a tall base, and serving said small quantity of bulk product.
